(19) United States
(12) Patent Application Publication
(10) Pub. No.: US 2025/0300741 A1
(43) Pub. Date: Sep. 25, 2025

(54) TRANSMITTING APPARATUS AND SIGNAL GENERATION METHOD

(71) Applicant: NIPPON TELEGRAPH AND TELEPHONE CORPORATION, Tokyo (JP)

(72) Inventors: Ryo KOMA, Musashino-shi (JP); Kazutaka HARA, Musashino-shi (JP); Junichi KANI, Musashino-shi (JP)

(73) Assignee: NIPPON TELEGRAPH AND TELEPHONE CORPORATION, Tokyo (JP)

(21) Appl. No.: 18/861,411

(22) PCT Filed: May 12, 2022
(86) PCT No.: PCT/JP2022/020027

§ 371 Date: Oct. 29, 2024

(51) Int. Cl. H04B 10/54; H04B 10/50; H04J 14/06

(52) U.S. Cl. CPC H04B 10/54; H04B 10/503; H04J 14/06

(57) ABSTRACT

A transmitting apparatus includes a direct modulation laser, a branching unit, a first signal generation unit, a second signal generation unit, and a polarized wave multiplexing unit. The branching unit branches continuous phase frequency shift keying signal light having been generated by the direct modulation laser by applying a first modulation signal into first branch light and second branch light. The first signal generation unit generates first polarized wave signal light obtained by removing an intensity modulation component having been generated by the direct modulation laser by applying the first modulation signal from the first branch light. The second signal generation unit generates second polarized wave signal light obtained by removing the intensity modulation component from the second branch light and adding an intensity modulation component to the second branch light by applying a second modulation signal, the second polarized wave being orthogonal to the first polarized wave. The polarized wave multiplexing unit multiplexes the signal light for the first polarized wave and the signal light for the second polarized wave.

### TECHNICAL FIELD

The present invention relates to a transmitting apparatus and a signal generation method.

### BACKGROUND ART

Currently, in an optical subscriber system network, a passive optical network (PON) system is used to economically provide a high-speed communications service to users. In the PON system, a plurality of optical network units (ONUs) share an optical line terminal (OLT) and a part of an optical fiber transmission line.

For the future, it has been proposed to use an all-photonics network (APN) for communication between users, including not only a subscriber system network (NW) but also high-speed and low-delay wireless services such as 5G and 6G and NWs requiring low delay such as a data center NW (refer to, for example, Non Patent Literature 1). In an APN, it is assumed that communication is accommodated in an optical direct connection NW by eliminating photoelectric conversion and electrical routing processing as much as possible on a communication path between users.

How to increase a speed and increase a transmission distance while keeping a configuration of a user device disposed on a user side simple and economical is a task common to both of them.

Therefore, in a PON system, there is a technique for increasing a speed and increasing a transmission distance while keeping a configuration of a user device simple (refer to, for example, Non Patent Literature 2). FIG. 15 is a diagram illustrating a configuration of a PON system using this technology. An ONU that is a transmitter in uplink communication generates and transmits a binary continuous phase frequency shift keying (CPFSK) signal using a laser chirp by using an electro absorption (EA) modulator integrated direct modulation diode. An OLT that is a receiver in uplink communication performs digital coherent reception of a signal transmitted from the ONU.

FIG. 16 is a diagram illustrating a configuration example of an APN (refer to, for example, Non Patent Literature 3). At an APN, in communication between short-range user devices, an intensity modulated (IM) signal is transmitted and received by using an EA modulator integrated direct modulation diode similar to that described above. These short-range user devices directly communicate with each other by using a return function of a PhGW (optical gateway) that is an optical node of the APN. On the other hand, in long-range transmission, a user device uses CPFSK modulation for communication with a relay disposed in a local network.

As a conventional study on speeding up a CPFSK signal, there is a configuration of a transmitter that improves the multilevel degree of a signal applied to a direct modulation laser and improves the number of information bits that can be transmitted in one symbol (refer to, for example, Non Patent Literature 4). The multilevel modulation signal applied to the direct modulation laser of the transmitter is assumed to be a quaternary pulse amplitude modulation signal (pulse amplitude modulation 4 (PAM4)). FIG. 17 is a diagram illustrating an eye pattern of a modulation signal output from a direct modulation laser, FIG. 18 is a diagram illustrating a relationship between an applied current to the direct modulation laser and a center frequency and intensity, and FIG. 19 is a diagram illustrating an example of a reception constellation. As illustrated in FIG. 18, since the center frequency of the laser is dislocated according to the applied current, a signal is superimposed on a variation component of the frequency. Although the speed can be increased by using this method, the speed is only increased in the phase direction. Therefore, similarly to a multi-value phase shift keying (PSK) modulation method, in the case of the high multilevel degree, a distance between signal points decreases, and thus, an increase in the required SNR for securing predetermined signal quality becomes significant. In order to prevent SNR degradation due to narrowing of the distance between signal points due to multileveling only in the phase direction, there is also a method such as an M-value quadrature amplitude modulation method (M-QAM method). However, since the frequency modulation signal is generated by the direct modulation laser, there is also a disadvantage that an intensity modulation component generated with the generation of the CPFSK signal causes signal quality (SNR) to deteriorate as illustrated in FIG. 19.

In the technique in Non Patent Literature 4, in addition to multilevel modulation in the phase direction, a speed is increased through polarization multiplexing. In Non Patent Literature 4, in order to confirm the principle, verification is performed by generating a signal by using a single laser diode (LD), branching and delaying the signal on an optical fiber, making polarized waves orthogonal to each other, and then multiplexing the polarized waves. However, in terms of implementation, since it is necessary to apply independent frequency modulation to each polarized wave, a configuration in which signals for orthogonal polarized waves are generated by using two LDs is assumed.

FIG. 20 illustrates a configuration of a transmitter that transmits a binary CPFSK signal and an intensity of each polarized wave of the generated binary CPFSK signal. In FIG. 20, after a signal is independently applied to each direct modulation laser, polarized waves of signals are made orthogonal by using a polarization control element, and then the signals for the orthogonal polarized waves are multiplexed by a polarized wave multiplexer. FIG. 21 illustrates another configuration of the transmitter that transmits a binary CPFSK signal and an intensity of each polarized wave of the generated binary CPFSK signal. As illustrated in FIG. 21, it is possible to cancel out an intensity modulation component in the signal output from the direct modulation laser in combination with an intensity modulator such as an EA modulator similarly to in Non Patent Literature 2. As a result, it is possible to prevent deterioration in a CPFSK signal, but a configuration becomes slightly complicated.

In the case of the configuration in FIG. 21, it is assumed that each direct modulation laser operates independently. Therefore, as illustrated in FIG. 22, center frequencies F and F′ of respective polarized waves independently vary. FIG. 23 is a diagram illustrating a configuration example of a receiver assumed in a case of performing digital coherent reception of a signal as illustrated in FIG. 21, and FIG. 24 is a diagram illustrating a configuration example of a general digital signal processing circuit unit (DSP) used in the receiver illustrated in FIG. 23. IQ components of received XY-polarized waves are input to the DSP. A polarization state of a received signal randomly changes with fiber transmission. Therefore, after wavelength dispersion compensation, the DSP separates the signal for each polarized wave to be in a polarization state at the time of transmission through polarized wave separation/adaptive equalization processing. In this case, in a case where a center frequency is different for each polarized wave, it is necessary to estimate a frequency difference Δf (frequency offset) with local oscillator (LO) light independently for each polarized wave, and thus a DSP scale increases.

### CITATION LIST

### Non Patent Literature

Non Patent Literature 1: Kawahara et al., “Optical full mesh network configuration technology supporting all-photonics network”, NTT Technical Journal, Vol. 32, No. 3, 2020, pp. 18-21.
Non Patent Literature 2: M. Fujiwara, R. Koma, J. Kani, K. Suzuki and A. Otaka, “Performance evaluation of CPFSK transmitters for TDM-based digital coherent PON upstream”, 2017 Optical Fiber Communications Conference and Exhibition (OFC), 2017
Non Patent Literature 3: R. Koma, K. Hara, T. Kanai, J. Kani and T. Yoshida, “Novel EA-DFB Mode-Switching Transmitter Supporting Continuous Phase Frequency Shift Keying and Intensity Modulation for All-Photonics Network”, 2021 European Conference on Optical Communication (ECOC), 2021, doi: 10.1109/ECOC52684.2021.9605834.
Non Patent Literature 4: D. Che, F. Yuan, Q. Hu and W. Shieh, “Frequency Chirp Supported Complex Modulation of Directly Modulated Lasers”, Journal of Lightwave Technology, vol. 34, no. 8, pp. 1831-1836, Apr. 15, 2016, doi: 10.1109/JLT.2015.2512298.

### SUMMARY OF INVENTION

### Technical Problem

In a CPFSK signal transmission/reception system using the direct modulation laser that has been studied so far, only a frequency modulation component is focused without detecting an intensity modulation component accompanying bias modulation of the direct modulation laser. Although there is an example in which high speed is achieved by polarization multiplexing, since a transmitter realizes polarization multiplexing by using two DFB lasers, a circuit scale increases.

In view of the above circumstances, an object of the present invention is to provide a transmitting apparatus and a signal generation method capable of performing polarization multiplexing at a high transmission speed without increasing a circuit scale.

### Solution to Problem

According to an aspect of the present invention, there is provided a transmitting apparatus including a direct modulation laser; a branching unit that branches continuous phase frequency shift keying signal light having been generated by the direct modulation laser by applying a first modulation signal into first branch light and second branch light; a first signal generation unit that generates first polarized wave signal light obtained by removing an intensity modulation component generated by the direct modulation laser by applying a first modulation signal from the first branch light; a second signal generation unit that generates signal light for a second polarized wave obtained by removing the intensity modulation component from the second branch light and adding an intensity modulation component to the second branch light by applying a second modulation signal, the second polarized wave being orthogonal to the first polarized wave; and a polarized wave multiplexing unit that multiplexes the first polarized wave signal light and the second polarized wave signal light.

According to another aspect of the present invention, there is provided a signal generation method including a branching step of branching continuous phase frequency shift keying signal light having been generated by a direct modulation laser by applying a first modulation signal into first branch light and second branch light; a first signal generation step of generating first polarized wave signal light obtained by removing an intensity modulation component generated by the direct modulation laser by applying the first modulation signal from the first branch light; a second signal generation step of generating second polarized wave signal light obtained by removing the intensity modulation component from the second branch light and adding an intensity modulation component to the second branch light by applying a second modulation signal, the second polarized wave being orthogonal to the first polarized wave; and a polarized wave multiplexing step of multiplexing the first polarized wave signal light and the second polarized wave signal light.

### Advantageous Effects of Invention

According to the present invention, it is possible to perform polarization multiplexing at a high transmission speed without increasing a circuit scale.

### BRIEF DESCRIPTION OF DRAWINGS

FIG. 1 is a configuration diagram of a transmitter according to a first embodiment of the present invention.

FIG. 2 is a diagram illustrating an example of output signal light of a direct modulation laser and a polarization state thereof according to the first embodiment.

FIG. 3 is a diagram illustrating an example of output signal light of a first intensity modulator and a polarization state thereof according to the first embodiment.

FIG. 4 is a diagram illustrating an example of output signal light of a second intensity modulator and a polarization state thereof according to the first embodiment.

FIG. 5 is a flowchart illustrating processing of the transmitter according to the first embodiment.

FIG. 6 is a configuration diagram of a transmitter according to the first embodiment.

FIG. 7 is a configuration diagram of a transmitter according to a modification example of the first embodiment.

FIG. 8 is a configuration diagram of a transmitter according to a modification example of the first embodiment.

FIG. 9 is a configuration diagram of a transmitter according to a second embodiment.

FIG. 10 is a configuration diagram of a transmitter according to the second embodiment.

FIG. 11 is a configuration diagram of a receiver according to a third embodiment.

FIG. 12 is a configuration diagram of a receiver according to the third embodiment.

FIG. 13 is a configuration diagram of a receiver according to the third embodiment.

FIG. 14 is a configuration diagram of a signal processing circuit according to the third embodiment.

FIG. 15 is a diagram illustrating a configuration of a PON system.

FIG. 16 is a diagram illustrating a configuration example of an APN.

FIG. 17 is a diagram illustrating an eye pattern of a multilevel modulation signal.

FIG. 18 is a graph illustrating a relationship between a current applied to a direct modulation laser, a center frequency, and an intensity.

FIG. 19 is a diagram illustrating an example of a reception constellation.

FIG. 20 is a diagram illustrating a configuration of a transmitter and an intensity of each polarized wave.

FIG. 21 is a diagram illustrating a configuration of a transmitter and an intensity of each polarized wave.

FIG. 22 is a diagram illustrating an intensity of each polarized wave of a signal output by a transmitter.

FIG. 23 is a diagram illustrating a configuration of a receiver.

FIG. 24 is a diagram illustrating a configuration of a DSP.

### DESCRIPTION OF EMBODIMENTS

Hereinafter, embodiments of the present invention will be described in detail with reference to the drawings. In the drawings, the same constituents are denoted by the same reference numerals, and the description thereof will be omitted.

In the present embodiment, a transmitter modulates an intensity modulation component and a frequency modulation component independently for respective polarized waves, and simultaneously transmits the components, thereby achieving a high transmission speed per wavelength. Since the intensity modulation component and the frequency modulation component are transmitted separately for the respective polarized waves, a CPFSK signal for transmitting the frequency modulation component is not subjected to SNR degradation due to the intensity modulation. Since the modulated signals for both polarized waves are transmitted by a single laser, not only can the speed be increased with a simple configuration, but also the influence of the independent frequency variation for each polarized wave generated when two lasers are used can be removed, and a DSP resource related to the frequency offset can be reduced.

### First Embodiment

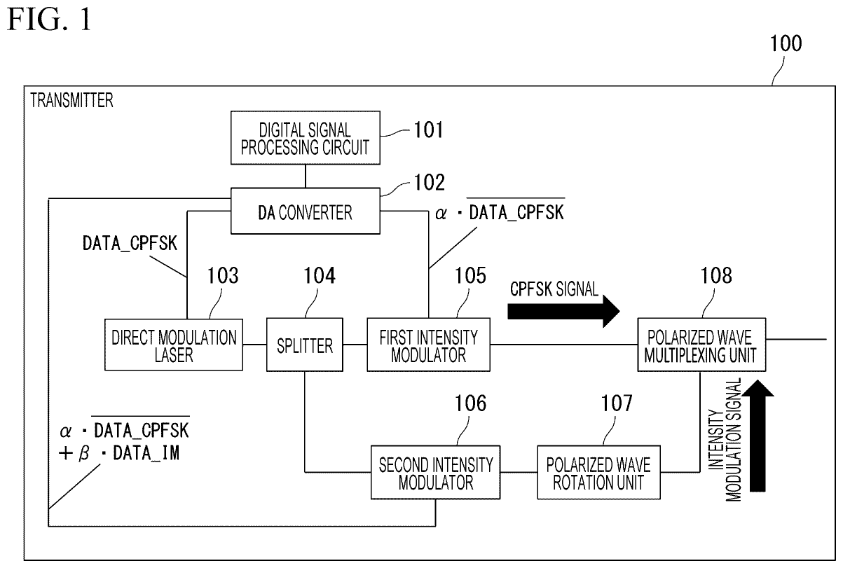

FIG. 1 is a configuration diagram of a transmitter 100 according to a first embodiment. The transmitter 100 includes a digital signal processing circuit 101, a digital-to-analog (DA) converter 102, a direct modulation laser 103, a splitter 104, a first intensity modulator 105, a second intensity modulator 106, a polarized wave rotation unit 107, and a polarized wave multiplexing unit 108. FIG. 1 illustrates a configuration for applying a binary amplitude shift keying (ASK) signal.

The digital signal processing circuit 101 is a signal generation circuit of a digital signal. The digital signal processing circuit 101 generates a modulation signal and outputs the generated modulation signal to the DA converter 102. The digital signal processing circuit 101 outputs DATA_CPFSK, α·⁻DATA_CPFSK, and α·⁻DATA_CPFSK+β·DATA_IM to the DA converter 102. “⁻DATA_CPFSK” indicates that “⁻” is written on “DATA_CPFSK”. α and β are coefficients that will be described later. Values of α and β are determined in advance. DATA_CPFSK is an amplitude modulation signal for transmitting first data. ⁻DATA_CPFSK is a modulation signal that cancels out an intensity modulation component generated in the direct modulation laser 103 by applying DATA_CPFSK. DATA_IM is an intensity modulation (IM) signal for transmitting second data.

The DA converter 102 converts the DATA_CPFSK, α·⁻DATA_CPFSK, and α·⁻DATA_CPFSK+β·DATA_IM that are the modulation signals generated by the digital signal processing circuit 101 from digital signals to analog signals. The DA converter 102 applies DATA_CPFSK to the direct modulation laser 103. The DA converter 102 outputs α·⁻DATA_CPFSK to the first intensity modulator 105, and outputs α·⁻DATA_CPFSK+β·DATA_IM to the second intensity modulator 106.

The direct modulation laser 103 is, for example, a distributed-feedback laser (DFB). By applying DATA_CPFSK output from the DA converter 102 to the direct modulation laser 103, the direct modulation laser 103 generates a continuous phase frequency-shift keying (CPFSK) signal.

The splitter 104 branches the CPFSK signal output from the direct modulation laser 103 into two signals of the same polarized wave. The splitter 104 outputs one of the two branched CPFSK signals to the first intensity modulator 105 and outputs the other CPFSK signal to the second intensity modulator 106.

The first intensity modulator 105 applies α·⁻DATA_CPFSK that is an intensity modulation component removal signal output from the DA converter 102 to the CPFSK signal input from the splitter 104. α is a coefficient for setting the degree of modulation of a signal applied to the first intensity modulator 105 in order to cancel out an intensity modulation component of a light source of the direct modulation laser 103. The first intensity modulator 105 outputs the CPFSK signal in which the intensity modulation component is canceled out by applying α·⁻DATA_CPFSK to the polarized wave multiplexing unit 108.

The second intensity modulator 106 generates a modulation signal obtained by applying α·⁻DATA_CPFSK+β·DATA_IM output from the DA converter 102 to the CPFSK signal input from the splitter 104. α·⁻DATA_CPFSK+β·DATA_IM is an applied modulation signal for adding a signal component to be transmitted through intensity modulation, in addition to a modulation signal that cancels out an intensity modulation component generated in the direct modulation laser 103 by applying DATA_CPFSK. β is a coefficient for setting the degree of modulation of the intensity modulation signal to any value. For example, in the case of binary modulation, an extinction ratio between a mark (1) and a space (0) of a signal can be changed by changing a value of the coefficient α and a value of the coefficient β. The second intensity modulator 106 outputs the generated intensity modulation signal to the polarized wave rotation unit 107.

The polarized wave rotation unit 107 rotates a polarized wave of the intensity modulation signal input from the second intensity modulator 106 and thus converts the input intensity modulation signal into an intensity modulation signal orthogonal thereto. The polarized wave rotation unit 107 outputs the intensity modulation signal after conversion to the polarized wave multiplexing unit 108. The polarized wave multiplexing unit 108 multiplexes the CPFSK signal input from the first intensity modulator 105 and the intensity modulation signal input from the polarized wave rotation unit 107, and outputs multiplexed signal light. The signal light output from the polarized wave multiplexing unit 108 is output to an optical transmission line (not illustrated). The optical transmission line is, for example, an optical fiber.

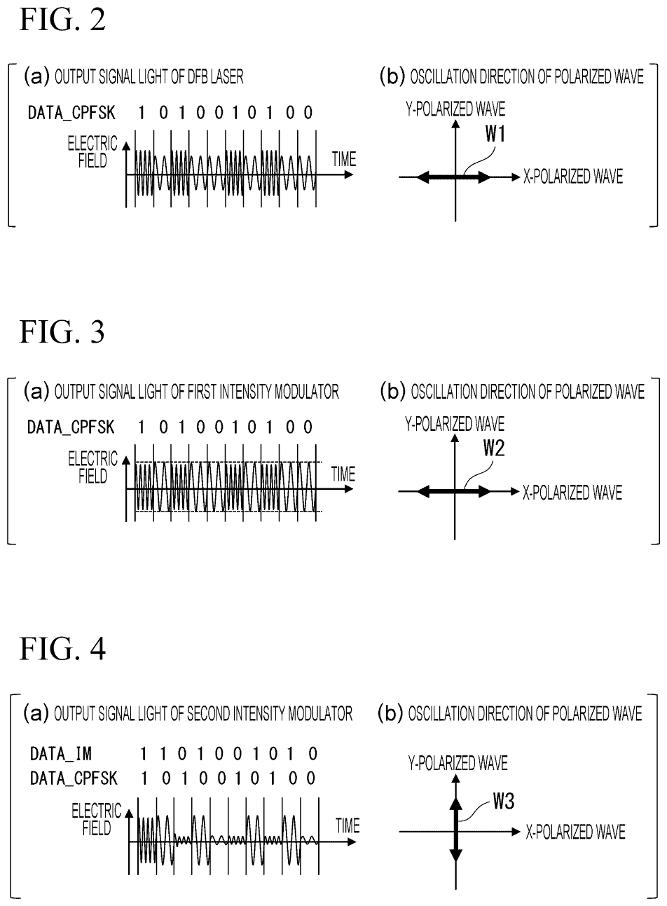

FIG. 2 is a diagram illustrating an example of output signal light of the direct modulation laser 103 and a polarization state thereof. Here, it is assumed that the direct modulation laser 103 is a DSP laser. It is assumed that a polarized wave of a signal output from the direct modulation laser 103 is a linearly polarized wave. A linearly polarized wave output from the direct modulation laser 103 is defined as an X-polarized wave, and a polarized wave orthogonal to the X-polarized wave is defined as a Y-polarized wave. FIG. 2(a) illustrates a correspondence between DATA_CPFSK and an electric field of the CPFSK signal output from the direct modulation laser 103. FIG. 2(b) illustrates an oscillation direction W1 of the polarized wave of the CPFSK signal output from the direct modulation laser 103.

A_{m_CPFSK} is an intensity modulation component generated by the direct modulation laser 103, ωₘ is an angular frequency of frequency-modulated signal light, t is time, and θ₀ is a phase that does not change with time. A signal E_{sig}, which is a CPFSK signal output from the direct modulation laser 103, is expressed by Formula (1). Here, the influence of a phase change (chirp) accompanying the external intensity modulation as an ideal state is not taken into consideration.

$$\begin{matrix}[ Math . 1 ] & \\ {E}_{sig} = {Am}_{\_ CPFSK} {e}^{j ( {ω}_{m \_ CPFSK} t - {θ}_{0} )} & ( 1 )\end{matrix}$$

FIG. 3 is a diagram illustrating an example of output signal light of the first intensity modulator 105 and a polarization state thereof. FIG. 3(a) illustrates a correspondence between DATA_CPFSK and an electric field of the output signal light (CPFSK signal) from the first intensity modulator 105. FIG. 3(b) illustrates an oscillation direction W2 of the polarized wave of the output signal light from the first intensity modulator 105. Since the intensity modulation component generated by the direct modulation laser 103 is removed, a signal amplitude of the output signal light from the first intensity modulator 105 has a constant value (A). An output amplitude E_{sig_X} of the output signal light from the first intensity modulator 105 is expressed by Formula (2).

$$\begin{matrix}[ Math . 2 ] & \\ {E}_{sig \_ X} = {Ae}^{j ( {ω}_{m \_ CPFSK} t - {θ}_{0} )} & ( 2 )\end{matrix}$$

FIG. 4 is a diagram illustrating an example of output signal light of the second intensity modulator 106 and a polarization state thereof. FIG. 4(a) illustrates a correspondence between the DATA_CPFSK and DATA_IM signals and an electric field of the output signal light (IM signal) from the second intensity modulator 106. FIG. 4(b) illustrates an oscillation direction W3 of a polarized wave after the polarized wave rotation unit 107 rotates a polarized wave of the output signal light output from the second intensity modulator 106. The second intensity modulator 106 applies a new intensity modulation component while removing the intensity modulation component generated by the direct modulation laser 103 from the CPFSK signal output from the direct modulation laser 103. On the other hand, the frequency modulation component remains. Thus, an output signal light E_{sig_Y} is expressed by Formula (3). Note that A_{m_IM} is an intensity modulation component applied by the second intensity modulator 106.

$$\begin{matrix}[ Math . 3 ] & \\ {E}_{sig \_ Y} = {A}_{m \_ IM} {e}^{j ( {ω}_{m \_ CPFSK} t - {θ}_{0} )} & ( 3 )\end{matrix}$$

The signal light after the polarized wave multiplexing unit 108 has multiplexed the polarized waves is a sum of the output signal light E_{sig_X} and the output signal light E_{sig_Y} orthogonal to each other.

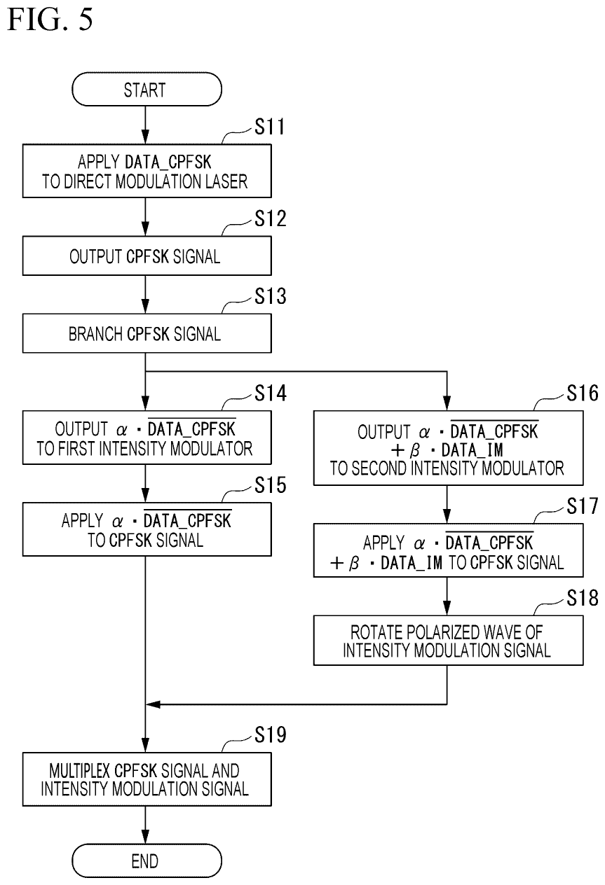

FIG. 5 is a flowchart illustrating processing of the transmitter 100. The digital signal processing circuit 101 outputs DATA_CPFSK that is an amplitude modulation signal, α·⁻DATA_CPFSK that is an intensity modulation component removal signal, and α·⁻DATA_CPFSK+β·DATA_IM that is an applied signal to the DA converter 102. The DA converter 102 converts DATA_CPFSK from a digital signal into an analog signal and applies the analog signal to the direct modulation laser 103 (step S11). The direct modulation laser 103 outputs a CPFSK signal generated by applying DATA_CPFSK (step S12). The splitter 104 branches the CPFSK signal output from the direct modulation laser 103 into two signals, and outputs the signals to the first intensity modulator 105 and the second intensity modulator 106 (step S13).

The DA converter 102 converts α·⁻DATA_CPFSK from a digital signal to an analog signal and outputs the analog signal to the first intensity modulator 105 (step S14). The first intensity modulator 105 applies α·⁻DATA_CPFSK to the CPFSK signal input from the splitter 104, and then outputs the signal to the polarized wave multiplexing unit 108 (step S15).

The DA converter 102 converts α·⁻DATA_CPFSK+β·DATA_IM from a digital signal to an analog signal, and outputs the analog signal to the second intensity modulator 106 (step S16). The second intensity modulator 106 applies α·⁻DATA_CPFSK+β·DATA_IM to the CPFSK signal input from the splitter 104 to generate an intensity modulation signal, and outputs the generated intensity modulation signal to the polarized wave rotation unit 107 (step S17).

The polarized wave rotation unit 107 rotates a polarized wave of the intensity modulation signal input from the second intensity modulator 106 and thus converts the input intensity modulation signal into an intensity modulation signal for a polarized wave orthogonal thereto (step S18). The polarized wave rotation unit 107 outputs the intensity modulation signal after conversion to the polarized wave multiplexing unit 108. The polarized wave multiplexing unit 108 multiplexes the CPFSK signal input from the first intensity modulator 105 and the intensity modulation signal input from the polarized wave rotation unit 107, and outputs multiplexed signal light (step S19).

In the above description, the polarized wave rotation unit 107 is provided at the subsequent stage of the second intensity modulator 106, but may be provided at the subsequent stage of the first intensity modulator 105. In the present embodiment, the signal generation unit is configured by the digital signal processing circuit 101 and the DA converter 102, but an analog signal generator not involving digital processing may be used as the signal generation unit. FIG. 1 illustrates the configuration in which a binary amplitude modulation signal (ASK) is applied, but an amplitude modulation signal having any multivalued degree may be used. A CPFSK signal and an IM signal may be modulated with independent multivalued degrees.

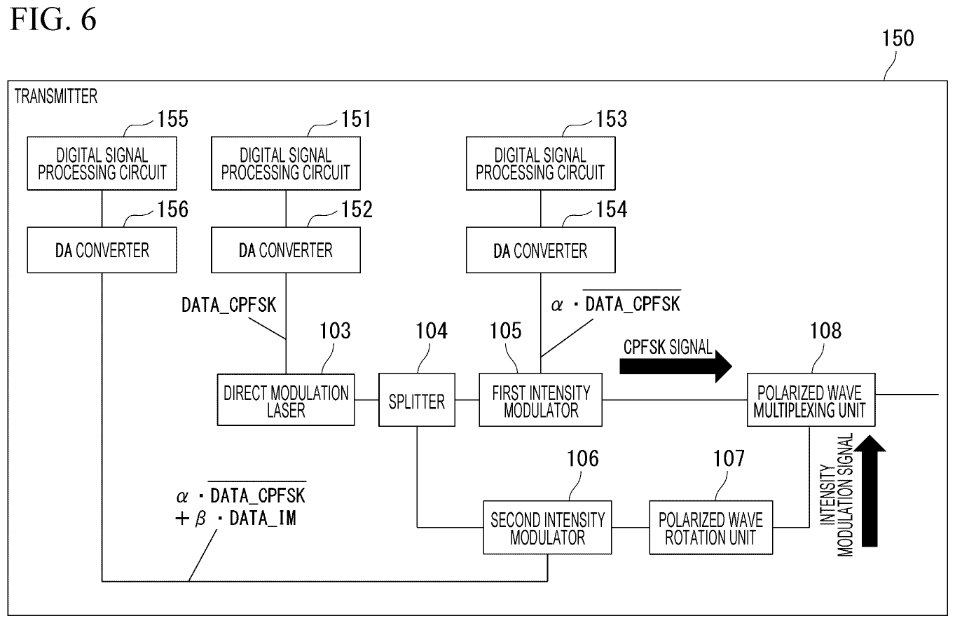

As illustrated in FIG. 6, signal generation units that generate signals to be output to the direct modulation laser 103, the first intensity modulator 105, and the second intensity modulator 106 may be configured by different devices. The devices may be used as independent paths for information transmission and monitoring control.

FIG. 6 is a configuration diagram of a transmitter 150 of the first embodiment. In FIG. 6, the same constituents as those of the transmitter 100 illustrated in FIG. 1 are denoted by the same reference numerals, and the description thereof will be omitted. The transmitter 150 illustrated in FIG. 6 is different from the transmitter 100 illustrated in FIG. 1 in that digital signal processing circuits 151, 153, and 155 and DA converters 152, 154, and 156 are provided instead of the digital signal processing circuit 101 and the DA converter 102.

The digital signal processing circuit 151 outputs DATA_CPFSK that is a digital signal. The DA converter 152 converts the DATA_CPFSK output from the digital signal processing circuit 151 from a digital signal into an amplitude-modulated analog signal and applies the analog signal to the direct modulation laser 103. The digital signal processing circuit 153 outputs α·⁻DATA_CPFSK that is a digital signal. The DA converter 154 converts the α·⁻DATA_CPFSK output from the digital signal processing circuit 153 from a digital signal to an analog signal and outputs the analog signal to the first intensity modulator 105. The digital signal processing circuit 155 outputs α·⁻DATA_CPFSK+β·DATA_IM. The DA converter 156 converts α·⁻DATA_CPFSK+β·DATA_IM output from the digital signal processing circuit 155 from a digital signal to an analog signal and outputs the analog signal to the second intensity modulator 106.

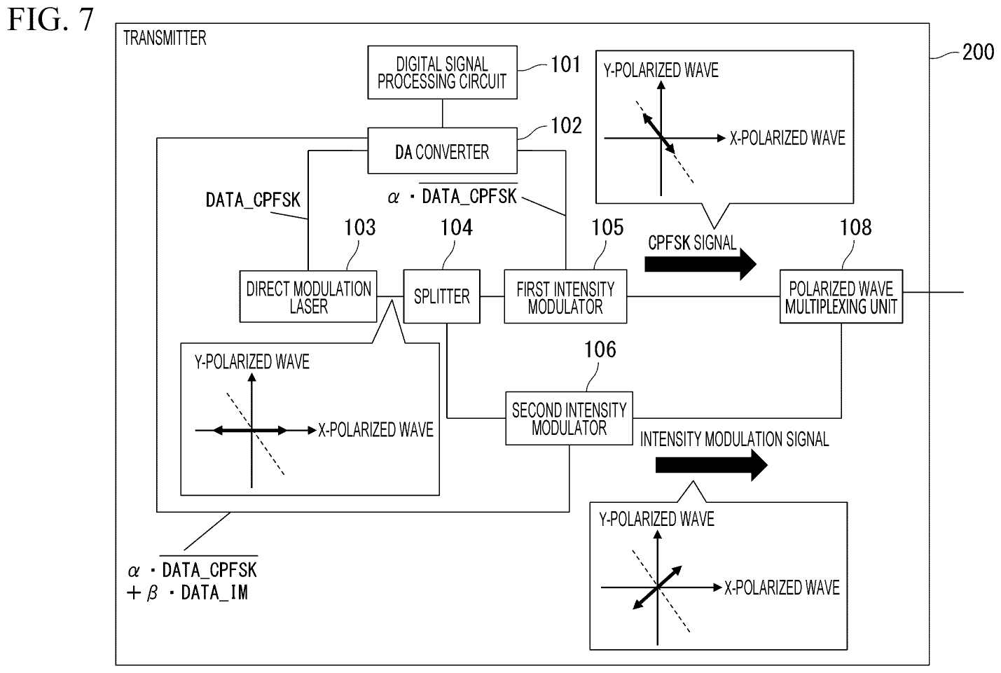

As a modification example of the first embodiment, polarized wave separation may be performed by using an element that performs polarized wave separation at an angle shifted by 45 degrees with respect to an output polarization axis of the direct modulation laser. FIG. 7 is a configuration diagram of a transmitter 200 according to a modification example. In FIG. 7, the same constituents as those of the transmitter 100 illustrated in FIG. 1 are denoted by the same reference numerals, and the description thereof will be omitted. The transmitter 200 illustrated in FIG. 7 is different from the transmitter 100 illustrated in FIG. 1 in that a polarized wave splitter 201 is provided instead of the splitter 104 and a polarized wave rotation unit 107 is not provided.

The polarized wave splitter 201 separates the CPFSK signal, which is the output signal light from the direct modulation laser 103, into two signals for polarized waves such as a polarized wave shifted by 45 degrees and a polarized wave shifted by −45 degrees from the output signal light. The polarized wave splitter 201 outputs the CPFSK signal for one polarized wave to the first intensity modulator 105 and outputs the CPFSK signal for the other polarized wave to the second intensity modulator 106. The first intensity modulator 105 applies α·⁻DATA_CPFSK output from the DA converter 102 to the CPFSK signal input from the polarized wave splitter 201 to remove the intensity modulation component, and then outputs the signal to the polarized wave multiplexing unit 108. The second intensity modulator 106 applies α·⁻DATA_CPFSK+β·DATA_IM output from the DA converter 102 to the CPFSK signal input from the polarized wave splitter 201 to generate an intensity modulation signal, and outputs the generated intensity modulation signal to the polarized wave multiplexing unit 108. The polarized wave multiplexing unit 108 multiplexes the output of the first intensity modulator 105 and the output of the second intensity modulator 106, and outputs multiplexed signal light.

The processing of the transmitter 200 is the same as the processing flow illustrated in FIG. 5 except for the following processing. That is, in step S13, the polarized wave splitter 201 separates the CPFSK signal, which is the output signal light from the direct modulation laser 103, into a signal for a polarized wave shifted by 45 degrees and a signal for a polarized wave shifted by −45 degrees, and outputs the respective signals for the polarized waves to the first intensity modulator 105 and the second intensity modulator 106. The transmitter 200 does not perform the process in step S18.

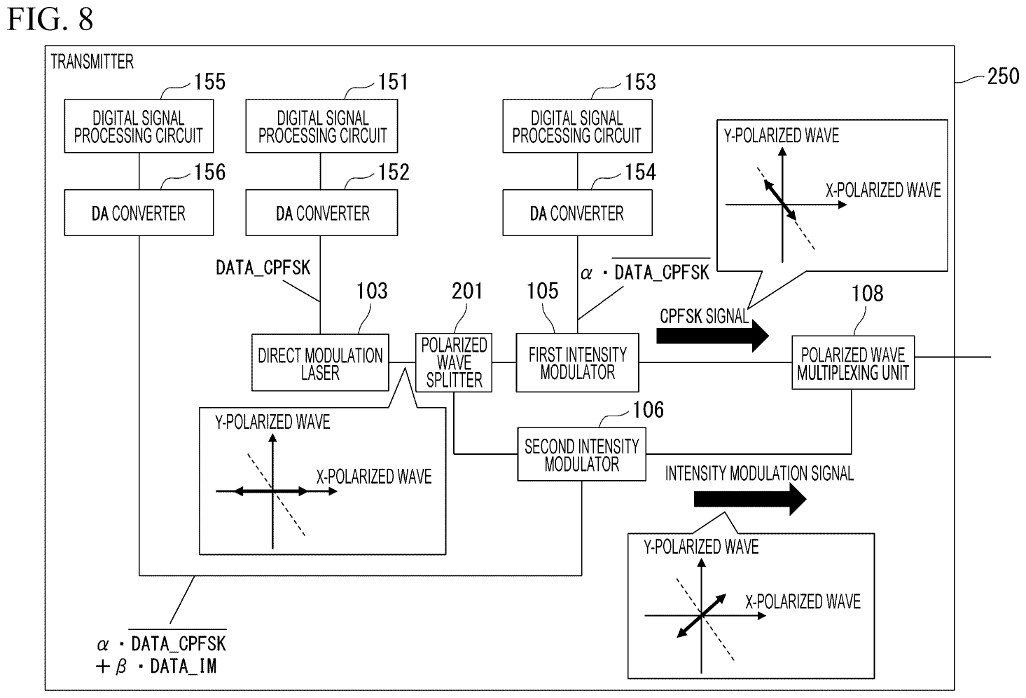

As illustrated in FIG. 8, signal generation units that generate signals to be output to the direct modulation laser 103, the first intensity modulator 105, and the second intensity modulator 106 may be configured by different devices. The devices may be used as independent paths for information transmission and monitoring control.

FIG. 8 is a configuration diagram of a transmitter 250. In FIG. 8, the same constituents as those of the transmitter 200 illustrated in FIG. 7 are denoted by the same reference numerals, and the description thereof will be omitted. The transmitter 250 illustrated in FIG. 8 is different from the transmitter 200 illustrated in FIG. 7 in that digital signal processing circuits 151, 153, and 155 and DA converters 152, 154, and 156 are provided instead of the digital signal processing circuit 101 and the DA converter 102. The digital signal processing circuits 151, 153, and 155 and the DA converters 152, 154, and 156 of the transmitter 250 operate similarly to the digital signal processing circuits 151, 153, and 155 and the DA converters 152, 154, and 156 of the transmitter 150 illustrated in FIG. 6.

### Second Embodiment

In a second embodiment, as disclosed in Reference Literature 1, a distributed-feedback (DFB) laser that radiates signal light bidirectionally to an active layer by removing a non-reflective coating is used as a light source. A CPFSK signal is generated through direct modulation of the DFB laser, and an intensity modulation component is removed and applied by external intensity modulators disposed at both ends of the DFB laser.
(Reference Literature 1) K. Zhong et al., “Double-Side EML for High Speed Optical Short Reach and Metro Applications”, 2017 Opto-Electronics and Communications Conference (OECC) and Photonics Global Conference (PGC), 2017, doi: 10.1109/OECC.2017.8115007.

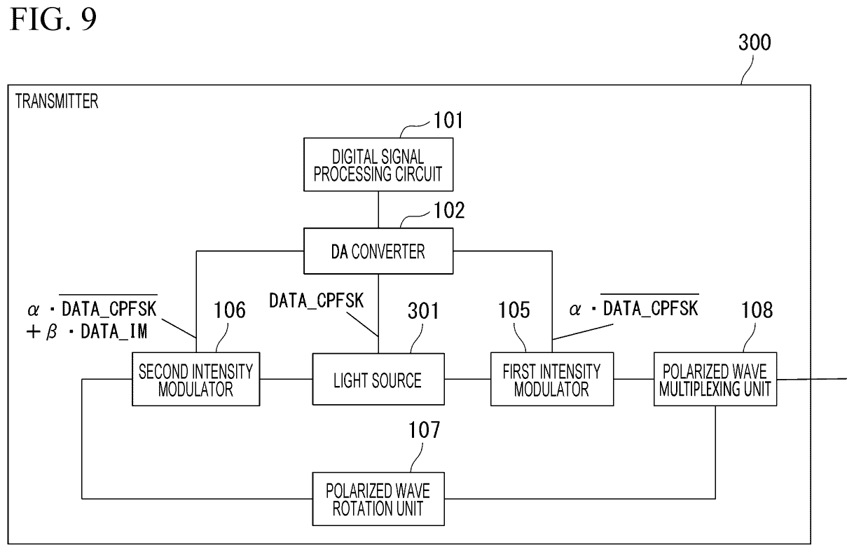

FIG. 9 is a configuration diagram of a transmitter 300. In the drawing, the same constituents as those of the transmitter 100 according to the first embodiment illustrated in FIG. 1 are denoted by the same reference numerals, and description thereof will be omitted. The transmitter 300 includes a digital signal processing circuit 101, a DA converter 102, a light source 301, a first intensity modulator 105, a second intensity modulator 106, a polarized wave rotation unit 107, and a polarized wave multiplexing unit 108.

The DA converter 102 applies DATA_CPFSK to the light source 301 as in the first embodiment. Similarly to the first embodiment, the DA converter 102 outputs α·⁻DATA_CPFSK to the first intensity modulator 105, and outputs α·⁻DATA_CPFSK+β·DATA_IM to the second intensity modulator 106.

The light source 301 is a DFB laser that radiates signal light bidirectionally to an active layer by removing a non-reflective coating. The light source 301 to which DATA_CPFSK is applied outputs a CPFSK signal to the first intensity modulator 105 and the second intensity modulator 106.

The first intensity modulator 105 applies α·⁻DATA_CPFSK to the CPFSK signal input from the light source 301. As a result, the first intensity modulator 105 outputs the CPFSK signal in which the intensity modulation component is canceled out to the polarized wave multiplexing unit 108. On the other hand, the second intensity modulator 106 applies α·⁻DATA_CPFSK+β·DATA_IM output from the DA converter 102 to the CPFSK signal input from the light source 301. As a result, the second intensity modulator 106 cancels out the intensity modulation component generated in the direct modulation laser 103, and further adds a signal component to be transmitted through the intensity modulation to generate an intensity modulation signal. The second intensity modulator 106 outputs the generated intensity modulation signal to the polarized wave rotation unit 107.

The polarized wave rotation unit 107 rotates a polarized wave of the intensity modulation signal input from the second intensity modulator 106 and thus converts the input intensity modulation signal into an intensity modulation signal orthogonal thereto. The polarized wave rotation unit 107 outputs the intensity modulation signal after conversion to the polarized wave multiplexing unit 108. The polarized wave multiplexing unit 108 multiplexes the CPFSK signal input from the first intensity modulator 105 and the intensity modulation signal input from the polarized wave rotation unit 107, and outputs a multiplex signal.

The processing of the transmitter 300 is the same as the processing flow illustrated in FIG. 5 except for the following process. That is, in step S11, the DA converter 102 applies DATA_CPFSK to the light source 301. In step S12, the light source 301 outputs the CPFSK signal generated by applying DATA_CPFSK to the first intensity modulator 105 and the second intensity modulator 106. The transmitter 300 does not perform the process in step S13.

In this configuration, a splitter is not required as compared with the first embodiment, and thus a configuration is simplified.

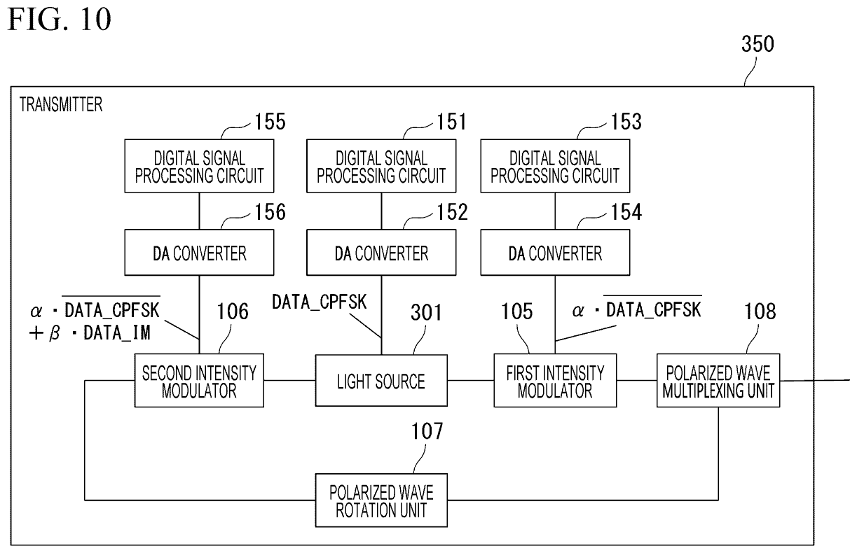

Note that, as illustrated in FIG. 10, signal generation units that generate signals to be output to the light source 301, the first intensity modulator 105, and the second intensity modulator 106 may be configured by different devices. The devices may be used as independent paths for information transmission and monitoring control.

FIG. 10 is a configuration diagram of a transmitter 350 in the present embodiment. In the transmitter 350 illustrated in FIG. 10, the same constituents as those of the transmitter 300 illustrated in FIG. 9 are denoted by the same reference numerals, and the description thereof will be omitted. The transmitter 350 illustrated in FIG. 10 includes digital signal processing circuits 151, 153, and 155 and DA converters 152, 154, and 156 instead of the digital signal processing circuit 101 and the DA converter 102. The digital signal processing circuits 151, 153, and 155 and the DA converters 152, 154, and 156 of the transmitter 350 operate similarly to the digital signal processing circuits 151, 153, and 155 and the DA converters 152, 154, and 156 of the transmitter 150 illustrated in FIG. 6.

### Third Embodiment

In the present embodiment, a configuration example of a receiver will be described. In the above-described embodiment, the transmitter independently modulates an intensity modulation signal and a CPFSK signal for respective polarized waves. Therefore, a signal can be received by both a photoelectric converter that performs square detection on a signal light electric field and a coherent receiver that can also decode phase information.

In the case of performing square detection on the signal light electric field, a square component of the polarization-multiplexed signal electric field E_{sig}, which is a received signal, is received. Therefore, a received signal i(t) after photoelectric conversion is as shown in Formula (4).

$$\begin{matrix}[ Math . 4 ] & \\ i ( t ) ≅ \vert Esig\_X \vert + \vert Esig\_Y \vert ≅ A + {A}_{{m}_{\_ IM}} & ( 4 )\end{matrix}$$

A of the first term on the right side of Formula (4) is a DC component, and thus does not change with time. A_{n_IM} of the second term on the right side indicates that only the intensity modulation component can be received without being affected by the CPFSK component.

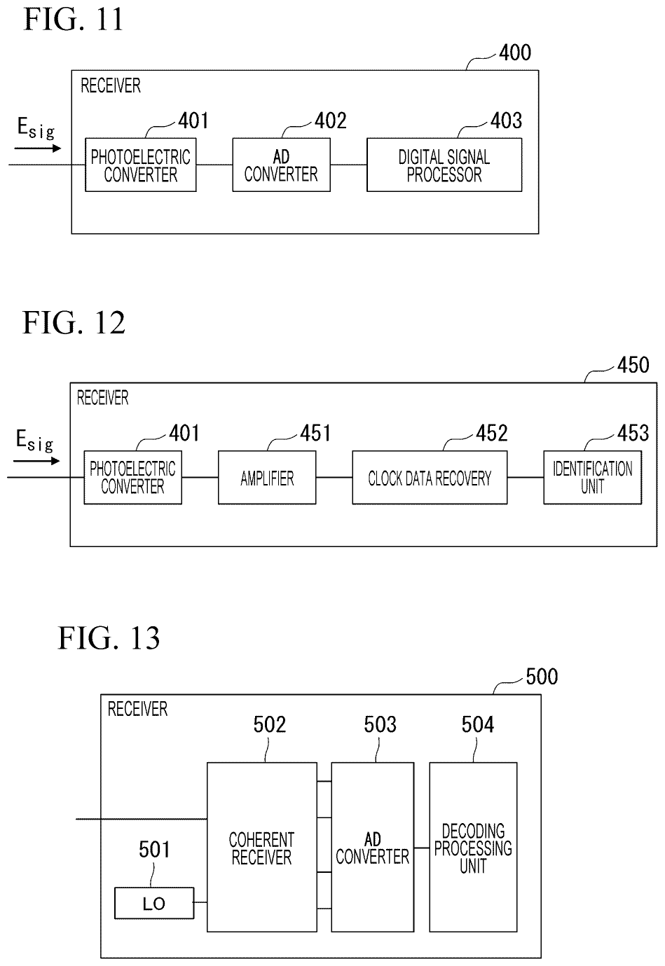

FIG. 11 is a configuration diagram of a receiver 400. The receiver 400 includes a photoelectric converter 401, an AD converter 402, and a digital signal processor 403. The photoelectric converter 401 receives signal light transmitted from the transmitter 100, 150, 200, 250, 300, or 350 and transmitted through an optical fiber. The photoelectric converter 401 performs square detection on a signal light electric field of the received signal light and receives the received signal i(t) expressed by Formula (4). The AD converter 402 converts the received signal from the photoelectric converter 401 from an analog signal to a digital signal. The digital signal processor 403 is a signal decoding unit. The digital signal processor 403 decodes an intensity modulation component of the received signal converted into the digital signal by the AD converter 402.

FIG. 12 is a configuration diagram of a receiver 450. In the drawing, the same constituents as those of the receiver 400 illustrated in FIG. 11 are denoted by the same reference numerals, and the description thereof will be omitted. The receiver 450 includes a photoelectric converter 401, an amplifier 451, a clock data recovery 452, and an identification unit 453. The amplifier 451 amplifies a received signal from the photoelectric converter 401. The clock data recovery 452 and the identification unit 453 are analog processing units. The clock data recovery 452 detects a signal timing of the received signal amplified by the amplifier 451. The identification unit 453 decodes the intensity modulation component of the received signal of which signal timing is detected by the clock data recovery 452.

FIG. 13 is a configuration diagram of a receiver 500. In the receiver 500, a coherent receiver receives a signal. The receiver 500 includes an LO 501, a coherent receiver 502, an AD converter 503, and a decoding processing unit 504. The LO 501 generates light with a single frequency. The coherent receiver 502 is a general polarization/phase diversity receiver. The coherent receiver 502 receives signal light transmitted from the transmitter 100, 150, 200, 250, 300, or 350 and transmitted through an optical fiber. The coherent receiver 502 obtains a signal converted into an electric signal by a beat between the received signal light and the local light output from the LO 501. The coherent receiver 502 performs polarized wave separation and phase separation of the received signal converted into the electrical signal to obtain an intensity modulation signal and a CPFSK signal. The coherent receiver 502 outputs the obtained intensity modulation signal and CPFSK signal to the AD converter 503. The AD converter 503 converts the intensity modulation signal and the CPFSK signal input from the coherent receiver 502 from analog signals to digital signals. The decoding processing unit 504 decodes data of each of the intensity modulation signal and the CPFSK signal.

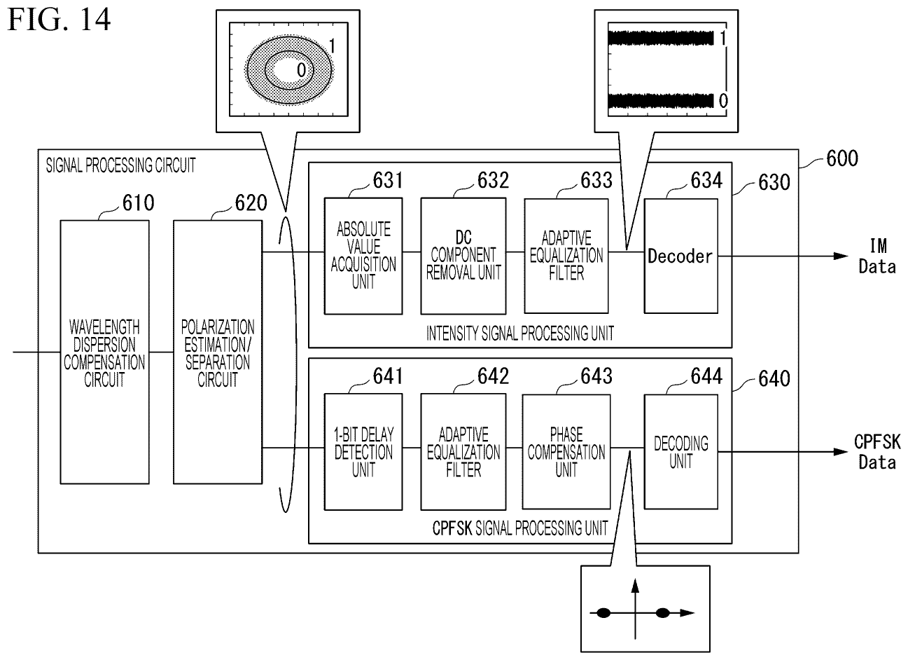

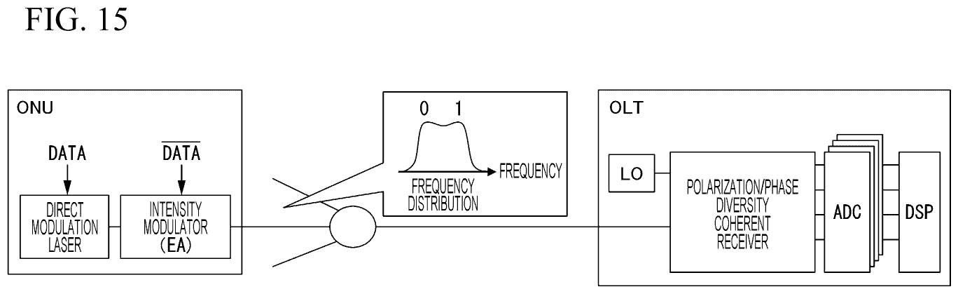

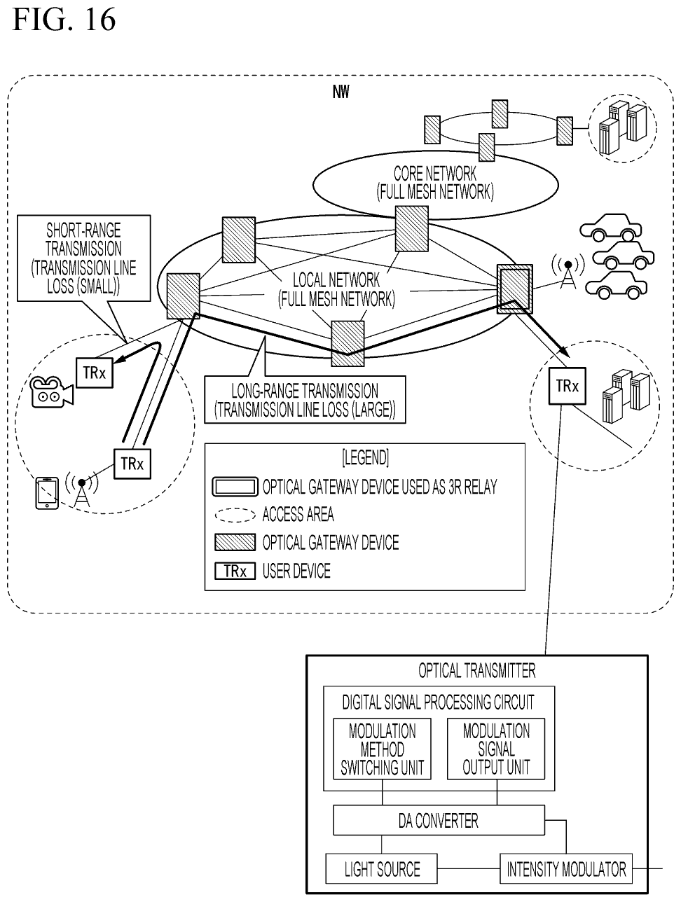

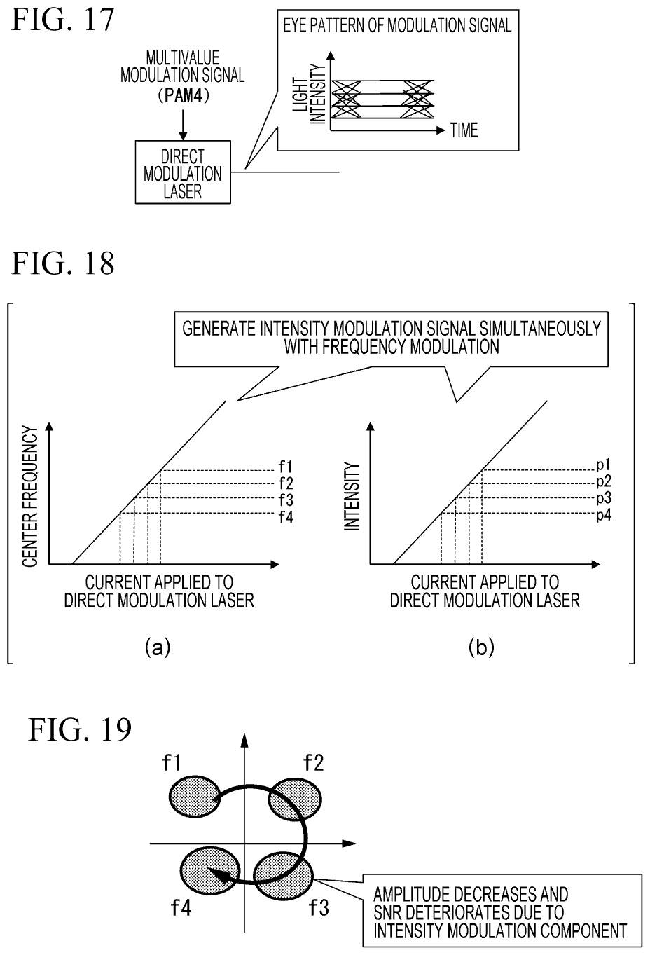

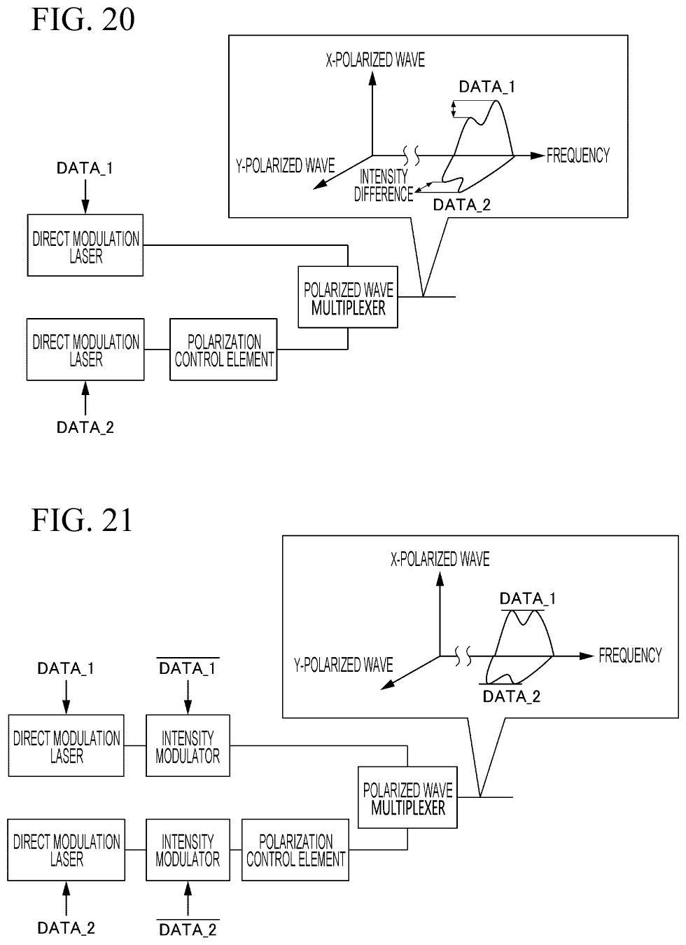

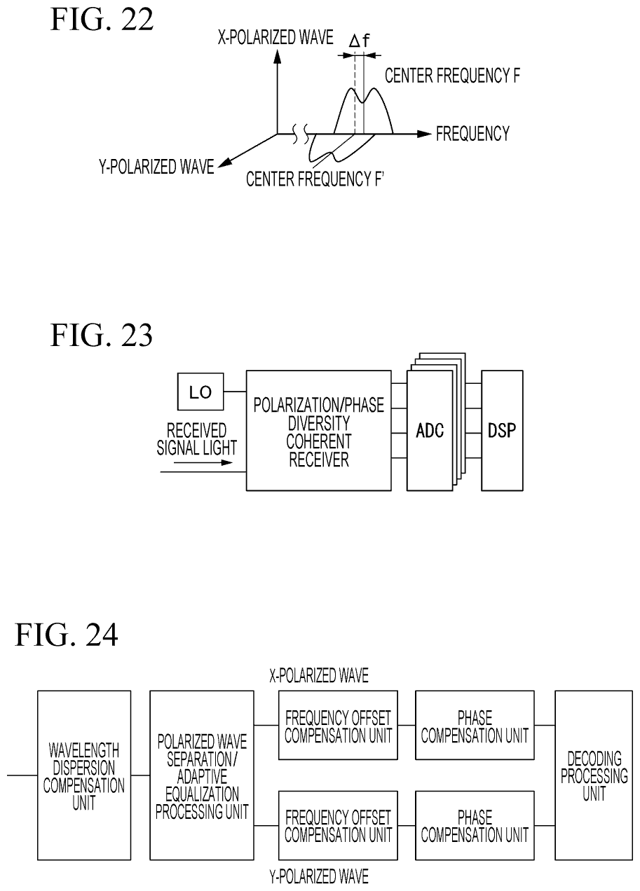

FIG. 14 is a diagram illustrating a configuration example of a signal processing circuit 600. The signal processing circuit 600 is used as the decoding processing unit 504 illustrated in FIG. 13. The signal processing circuit 600 includes a wavelength dispersion compensation circuit 610, a polarization estimation/separation circuit 620, an intensity signal processing unit 630, and a CPFSK signal processing unit 640.

The wavelength dispersion compensation circuit 610 estimates the wavelength dispersion of the signal light accompanying the fiber propagation and compensates for the estimated wavelength dispersion for the received signal. The wavelength dispersion compensation circuit 610 outputs the received signal in which the wavelength dispersion is compensated for to the polarization estimation/separation circuit 620. In a case where a polarization axis at the time of transmission is different from a predetermined polarization axis of the coherent receiver, or in a case where a polarization state of signal light varies due to polarized wave rotation or the like during fiber propagation, when a signal is received after polarized wave separation due to polarization diversity, an intensity signal and a CPFSK signal may be mixed in the received signal corresponding to each polarized wave. Therefore, the polarization estimation/separation circuit 620 estimates a polarization state, performs compensation such that the polarization state becomes a polarization state at the time of transmission, and separates the signal for each polarized wave on which an intensity modulation component and a CPFSK modulation component are superimposed. The polarization estimation/separation circuit 620 outputs the polarized wave of the intensity modulation signal among the complex signals obtained through the polarized wave separation to the intensity signal processing unit 630, and outputs the polarized wave of the CPFSK signal to the CPFSK signal processing unit 640.

The intensity signal processing unit 630 includes an absolute value acquisition unit 631, a direct current (DC) component removal unit 632, an adaptive equalization filter 633, and a decoder 634. The absolute value acquisition unit 631 of the intensity signal processing unit 630 calculates an absolute value of each complex signal input from the polarization estimation/separation circuit 620 to convert the complex signal into an intensity information signal. The DC component removal unit 632 receives the signal converted by the absolute value acquisition unit 631 and removes a DC component from each of the received signals. The adaptive equalization filter 633 receives the signal from which the DC component is removed by the DC component removal unit 632, and compensates for waveform deterioration of the received signal. The decoder 634 performs down-sampling processing on the signal of which the waveform degradation has been compensated for by the adaptive equalization filter 633, and then decodes the signal. As a result, data transmitted by the intensity modulation (IM) signal is obtained.

The CPFSK signal processing unit 640 receives the CPFSK signal according to the method disclosed in Non Patent Literature 2. The CPFSK signal processing unit 640 includes a 1-bit delay detection unit 641, an adaptive equalization filter 642, a phase compensation unit 643, and a decoding unit 644. The 1-bit delay detection unit 641 performs 1-bit delay detection on a polarization signal. The adaptive equalization filter 642 applies an adaptive equalization filter to the signal subjected to 1-bit delay detection by the 1-bit delay detection unit 641. The phase compensation unit 643 compensates for a phase of the signal to which the adaptive equalization filter is applied. The decoding unit 644 decodes a polarized wave of which the phase is compensated for. As a result, data transmitted by the CPFSK signal is obtained.

According to the above-described embodiment, a transmitting apparatus includes a direct modulation laser, a branching unit, a first signal generation unit, a second signal generation unit, and a polarized wave multiplexing unit. The branching unit branches continuous phase frequency shift keying signal light having been generated by the direct modulation laser by applying a first modulation signal into first branch light and second branch light. The first signal generation unit generates first polarized wave signal light obtained by removing an intensity modulation component having been generated by the direct modulation laser by applying the first modulation signal from the first branch light. The second signal generation unit generates second polarized wave signal light obtained by removing the intensity modulation component from the second branch light and adding the intensity modulation component to the second branch light by applying a second modulation signal, the second polarized wave being orthogonal to the first polarized wave.

The branching unit branches the continuous phase frequency shift keying signal light of the first polarized wave into the first branch light and the second branch light. The branching unit is, for example, the splitter 104 of the embodiment. The second signal generation unit removes the intensity modulation component generated by the direct modulation laser by applying the first modulation signal from the second branch light and adds the intensity modulation component by applying the second modulation signal to the second branch light, and then converts the second branch light into the second polarized wave. The second signal generation unit is, for example, the second intensity modulator 106 and the polarized wave rotation unit 107 of the embodiment.

The branching unit may branch the continuous phase frequency shift keying signal light of the second polarized wave into the first branch light and the second branch light. The branching unit is, for example, the splitter 104 of the embodiment. The first signal generation unit removes, from the first branch light, an intensity modulation component having been generated by the direct modulation laser by applying the first modulation signal, and then converts the first branch light into the first polarized wave. The first signal generation unit is, for example, the first intensity modulator 105 of the embodiment and the polarized wave rotation unit 107 provided at the subsequent stage of the first intensity modulator 105.

The branching unit branches the continuous phase frequency shift keying signal light into the first branch light of the first polarized wave and the second branch light of the second polarized wave. The branching unit is, for example, the polarized wave splitter 201 of the embodiment. The first signal generation unit removes, from the first branch light, an intensity modulation component having been generated by the direct modulation laser by applying the first modulation signal to generate first polarized wave signal light. The second signal generation unit removes the intensity modulation component from the second branch light and adds the intensity modulation component to the second branch light by applying the second modulation signal to generate second polarized wave signal light.

The transmitter includes a light source that performs direct modulation by applying a first modulation signal and outputs continuous phase frequency shift keying signal light in two directions, instead of the direct modulation laser and the branching unit. The light source is, for example, the light source 301 of the embodiment.

Although the embodiments of the present invention have been described in detail with reference to the drawings, a specific configuration is not limited to the embodiments, and includes design and the like within the scope not departing from the concept of the present invention.

### REFERENCE SIGNS LIST

100, 150, 200, 250, 300, 350 Transmitter
101, 151, 153, 155 Digital signal processing circuit
102, 152, 154, 156 DA converter
102 Converter
103 Direct modulation laser
104 Splitter
105 First intensity modulator
106 Second intensity modulator
107 Polarized wave rotation unit
108 Polarized wave multiplexing unit
201 Polarized wave splitter
301 Light source
400 Receiver
401 Photoelectric converter
402, 503 AD converter
403 Digital signal processor
450 Receiver
451 Amplifier
452 Clock data recovery
453 Identification unit
500 Receiver
501 LO
502 Coherent receiver
504 Decoding processing unit
600 Signal processing circuit
610 Wavelength dispersion compensation circuit
620 Polarization estimation/separation circuit
630 Intensity signal processing unit
631 Absolute value acquisition unit
632 DC component removal unit
633 Adaptive equalization filter
634 Decoder
640 CPFSK signal processing unit
641 1-bit delay detection unit
642 Adaptive equalization filter
643 Phase compensation unit
644 Decoding unit

1. A transmitting apparatus comprising:
a direct modulation laser;
a branching circuitry that branches continuous phase frequency shift keying signal light, that have been generated by applying a first modulation signal to the direct modulation laser, into first branch light and second branch light;
a first signal generator that generates first polarized wave signal light obtained by removing a first intensity modulation component from the first branch light, the first intensity modulation component having been generated by applying the first modulation signal to the direct modulation laser;
a second signal generator that generates second polarized wave signal light obtained by removing the first intensity modulation component from the second branch light and adding a second intensity modulation component to the second branch light caused by applying a second modulation signal to the second branch light, the second polarized wave being orthogonal to the first polarized wave; and
a polarized wave multiplexer that multiplexes the first polarized wave signal light and the second polarized wave signal light.

2. The transmitting apparatus according to claim 1, wherein
the branching circuitry branches the continuous phase frequency shift keying signal light of the first polarized wave into the first branch light and the second branch light, and
the second signal generator removes the first intensity modulation component from the second branch light, adds the second intensity modulation component to the second branch light caused by applying the second modulation signal to the second branch light, and then converts the second branch light into the second polarized wave signal light.

3. The transmitting apparatus according to claim 1, wherein
the branching circuitry branches the continuous phase frequency shift keying signal light of the second polarized wave into the first branch light and the second branch light, and
the first signal generator removes the first intensity modulation component from the first branch light and then converts the first branch light into the first polarized wave signal light.

4. The transmitting apparatus according to claim 1, wherein
the branching circuitry branches the continuous phase frequency shift keying signal light into the first branch light of the first polarized wave and the second branch light of the second polarized wave,
the first signal generator removes the first intensity modulation component from the first branch light to generate the first polarized wave signal light, and
the second signal generator removes the first intensity modulation component from the second branch light and adds the second intensity modulation component to the second branch light caused by applying the second modulation signal to the second branch light to generate the second polarized wave signal light.

5. The transmitting apparatus comprising:
a light source that performs direct modulation by being applied first modulation signal and outputs first continuous phase frequency shift keying signal light in a first direction and second continuous phase frequency shift keying signal light in a second direction;
a first signal generator that generates first polarized wave signal light obtained by removing first intensity modulation component from the first continuous phase frequency shift keying signal light, the first intensity modulation component having been generated by applying the first modulation signal to the light source;
a second signal generator that generates second polarized wave signal light obtained by removing the first intensity modulation component from the second continuous phase frequency shift keying signal light and adding a second intensity modulation component to the second continuous phase frequency shift keying signal light caused by applying a second modulation signal to the second continuous phase frequency shift keying signal light, the second polarized wave being orthogonal to the first polarized wave; and
a polarized wave multiplexer that multiplexes the first polarized wave signal light and the second polarized wave signal light.

6. A signal generation method comprising:
branching continuous phase frequency shift keying signal light, that have been generated by applying a first modulation signal to a direct modulation laser, into first branch light and second branch light;
generating first polarized wave signal light obtained by removing a first intensity modulation component from the first branch light, the first intensity modulation component having been generated by applying the first modulation signal to the direct modulation laser;
generating second polarized wave signal light obtained by removing the fir intensity modulation component from the second branch light and adding a second intensity modulation component to the second branch light caused by applying a second modulation signal to the second branch light, the second polarized wave being orthogonal to the first polarized wave; and
multiplexing the first polarized wave signal light and the second polarized wave signal light.
